(19) United States
(12) Patent Application Publication
(10) Pub. No.: US 2017/0306920 A1
(43) Pub. Date: Oct. 26, 2017

(54) The engine operated by the buoyancy of water

(71) Applicants: Ngoc Quy Pham, Ha nam (VN); Ngoc Truong Pham, Ha Nam (VN); Ngoc Quyen Pham, Ham Nam (VN)

(72) Inventors: Ngoc Quy Pham, Ha nam (VN); Ngoc Truong Pham, Ha Nam (VN); Ngoc Quyen Pham, Ham Nam (VN)

(21) Appl. No.: 15/509,500

(22) PCT Filed: Nov. 20, 2015
(86) PCT No.: PCT/VN2015/000015

§ 371 Date: Mar. 8, 2017

(30) Foreign Application Priority Data
Jan. 14, 2015 (VN) 1-2015-00123

(51) Int. Cl. F03B 17/04

(52) U.S. Cl. CPC F03B 17/04; F05B 2240/60; F05B 2260/503

(57) ABSTRACT

The invention relates to engine operated by the buoyancy of water, this engine is made up of water tank(16), the first device cluster (100) includes a shaft (1) and two gears (2a, 2b), at the teeth (24) there is a one-way air-supply valve (23), the second device cluster (200) includes a shaft (3) and two gears (4a, 4b). There is a difference that the third device clusters (300) includes two flanges (9a , 9b), a rectangular box (10) functioned to change the volume while coordinating activities with the structure of shaped rails (17) and (18), multiple third device clusters (300) are connected together by latches (15) forming a closed circle, the flanges (9a, 9b) of the closed circle are inserted fit the teeth (24) of the gears (2a, 2b) of the first device cluster (100) and mounted to fit the teeth (24) of the gears (4a, 4b) of the second device cluster (200).

### FIELD OF INVENTION

The invention relates to a specific engine that is hereunder the engine run by the buoyancy (Archimedes force) of water.

### The Known Solutions

Given the hydropower plants currently operated by power flowing water to generate electricity. But water resources for power generation is not sufficient for the development needs and annual growth of many countries, the downside is that water source is dependent on nature and reservoirs which occupy much space, causing an adverse effect on the environment.

### Technical Nature of Invention

The purpose of the invention is to use the energy from the buoyancy of water.

To achieve the above purpose of the invention, the engine is operated by the buoyancy of the water is made up of water tank, the first device cluster includes a crankshaft and 2 gears, the second device cluster includes a crankshaft and 2 gears, the third cluster consists of two flanges and a rectangular box with changeable volume function. Many third device clusters are connected together by the latches, forming a closed circle, is mounted on the gear and meshed with the teeth of the gears of the first and the second clusters of device.

Principle of Operation: When the water tank is empty, the third gear clusters, segments of GH (FIG. 2) are of the largest pore volume and the third device cluster of segment PQ, though having the smallest volume but with balanced gravity, the machine does not operate. When the tank is full of water, the third clusters of device of segment GH is of the largest pore volume, they will be pulled upwards by the buoyancy of the water on the water, and the third clusters of device of the segment PQ is of the smallest volume will pull each other sinking towards the bottom, so there appears a pull-up force by the buoyancy of a sequence of multiple clusters of the third cluster of segment GH, with total capacity of a series of multiple third device clusters of largest pore volume thus making four gears and two-crank shaft operate. Due to the operation, the third device clusters of segment QH at the bottom of the water tank is moving through the structure of wider shaped rails, having gradual larger volume, in order to complement the third clusters of segment GP above water surface. They also moves through the structure of smaller shaped rails so the volume has been smaller, and ready for the sinking-down cycle of this third cluster of device. Then, this constantly maintains the amount of the third clusters of device at the largest pore volume in the segment GH, and also constantly maintains the amount of the third device clusters at the smallest volume in the segment PQ, then the engine works continuously without stopping by the buoyancy of water.

The speed of the engine is adjusted by the high or low water levels in the water tank.

### FIGURE OF THE DRAWINGS

FIG. 1 is a perspective drawing three basic device clusters of the engine operated by buoyancy (Archimedes force) of water including first device cluster, the second device cluster, and multiple third device clusters.

FIG. 2, is shown along vertical section, showing the rectangular box of the third device clusters, having the largest volume segment in GH, and the rectangular box of the third device cluster at the PQ segment having the smallest volume, according to the invention.

FIG. 3 is a drawing showing the first device cluster includes a crankshaft and two gears and one-way air supply valve.

FIG. 4 is a drawing of two gears, in the position of the teeth having a one-way valve functioning providing air for the third device clusters when necessary to change the volume from the smallest to the largest.

FIG. 5, as the figure shows, the third device clusters are of the largest volume.

FIG. 6, as the figure shows, the third device clusters are of the smallest volume.

FIG. 7 is a drawing separating the details configuring into third device clusters.

FIG. 8, as the figure shows a rectangular box functioned to change the volume, is installed between two flanges of the third device clusters according to the invention.

FIG. 9, shows simulating rectangular box from left to right, when the volume is of largest, medium and smallest.

FIG. 10, shows the second device cluster include a shaft and two gears.

### DETAILED DESCRIPTION OF THE INVENTION

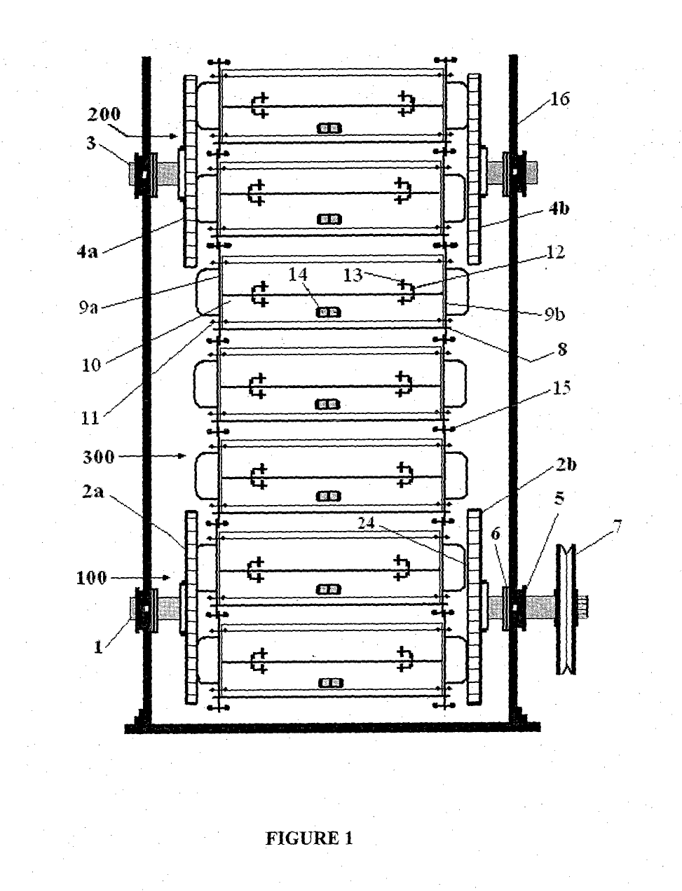

As shown in FIG. 1, the engine operated by the buoyancy of the water is made up of water tank 16, the first device cluster 100 includes a shaft 1 and two gears 2a and 2b, the second device cluster 200 includes a shaft 3 and two gears 4a, 4b, the third device cluster 300 includes two flanges 9a and 9b, supporting shaft of rectangular box 8, rectangular box 10, threaded positioning shaft 11, air release valve 14, ball-bearing bearings 5, and water blocker 6. Many third device clusters 300 are connected together by flanges 9a and 9b forming a closed circle, the flanges 9a, 9b of this closed circle is installed fitted with the teeth 24 of the gears 2a, 2b and 4a, 4b.

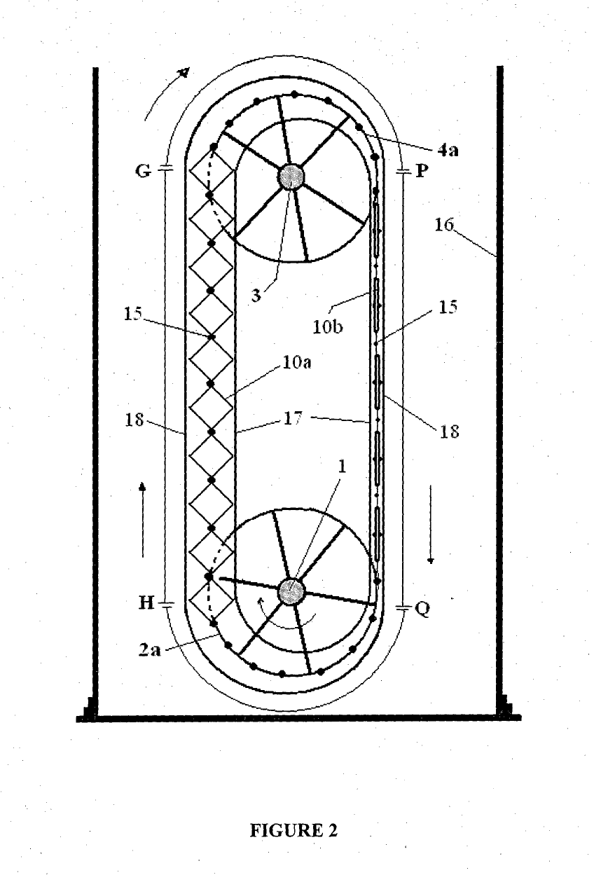

As shown in FIG. 2, many rectangular boxes 10a of the third device clusters 300 have the largest volume at segment GH, because the distance between the two rails 17 and 18 of this segment is of the largest, many rectangular boxes 10b of the third device clusters 300 are the smallest volume in the segment PQ because the distance between the two rails 17 and 18 of the segment PQ is of the smallest.

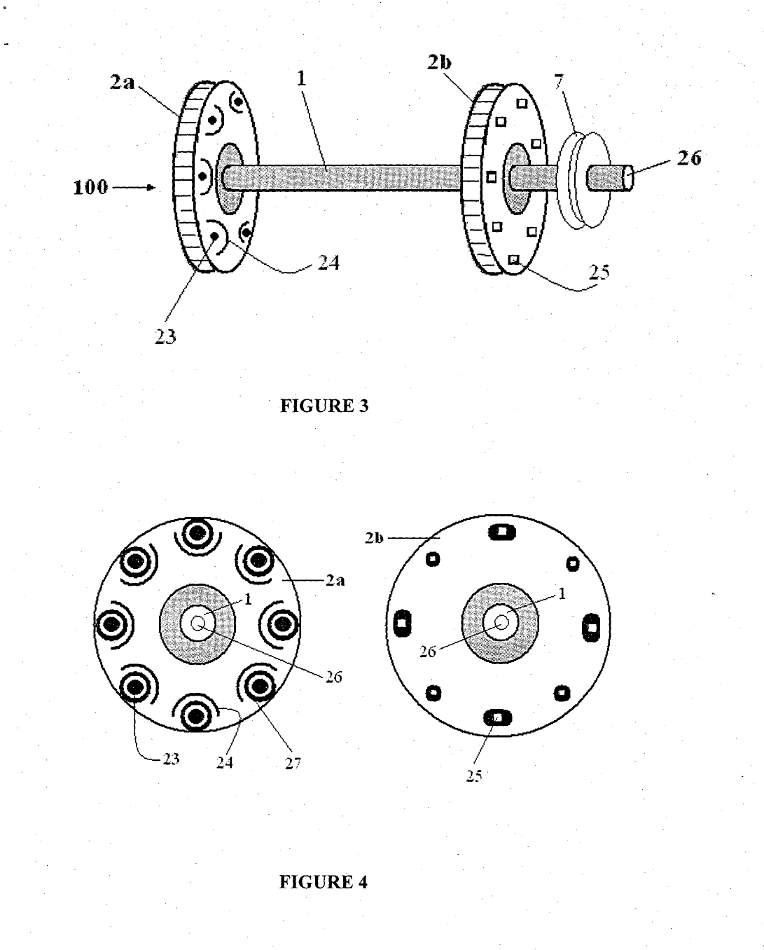

As shown in FIG. 3, the first device cluster 100 include a crankshaft 1 and two gears 2a and 2b, one-way air supply valve 23 and teeth 24.

As shown in FIG. 4, at the position of the tooth 24 and gears 2a and 2b there is a gasket 27 and one-way air supply valve 23 to supply air to the third device clusters 300, air is sucked from the environment itself, passing center hole of the shaft 26 is connected to the hollow chamber of gears 2a and 2b to the one-way air supply valve 23.

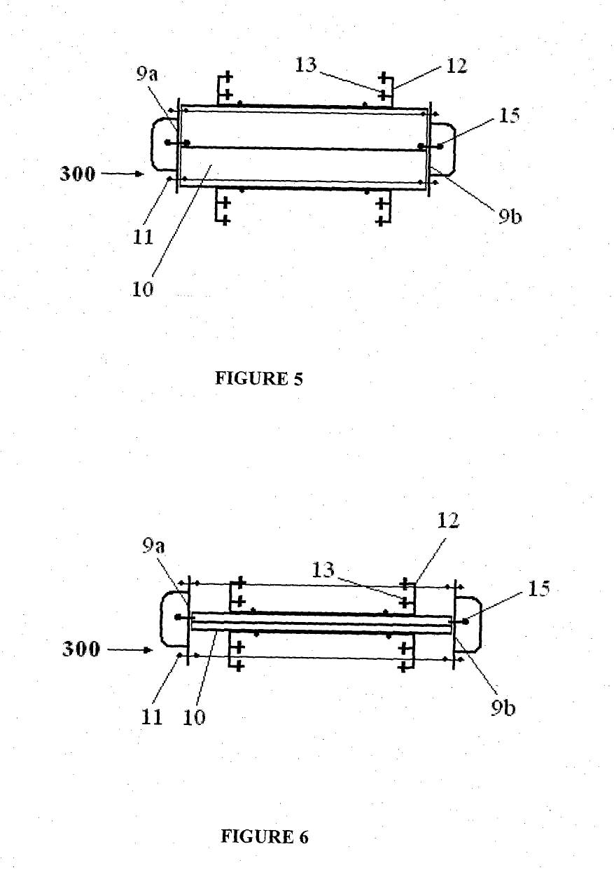

As shown in FIG. 5, the rectangular box 10 of the third device clusters 300 is of the largest volume, the bracket 12 and ball-bearing 13.

As shown in FIG. 6, the rectangular box 10 of the third device cluster 300 is of the smallest volume, the bracket 12 and ball-bearing 13.

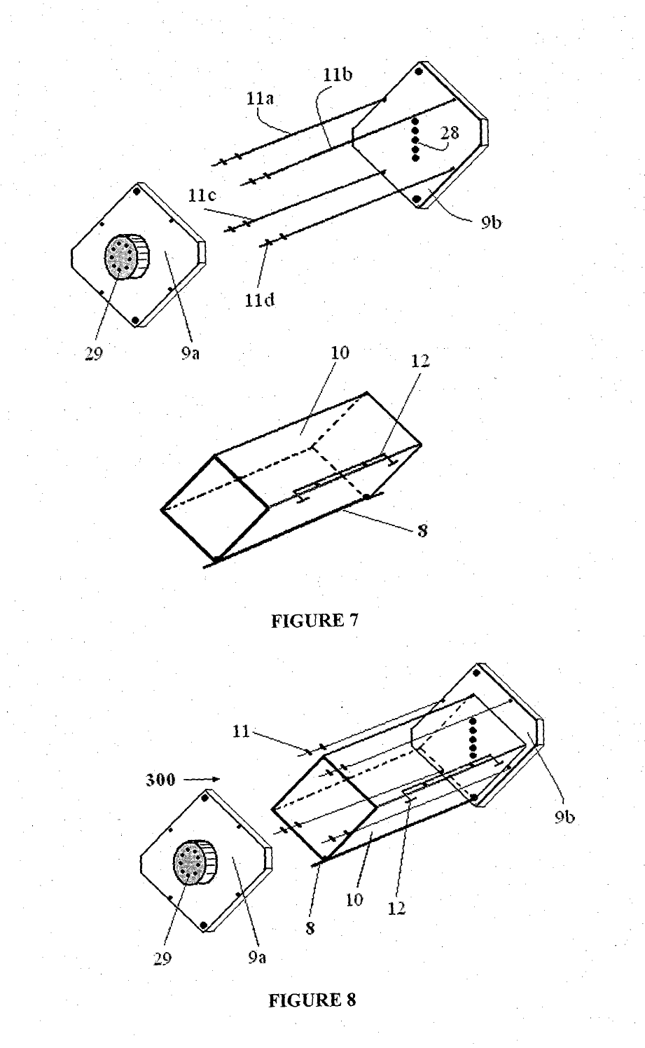

As shown in FIG. 7, is shown in detail constituent the third device clusters 300, including two flanges 9a and 9b, on the flange 9a has the 29^{th} hole and 9b has the 28^{th} hole, the support shaft of rectangular box 8, has four threaded positioning shafts 11a, 11b, 11c, 11d, and a rectangular box 10 functioned to change volume, according to the invention.

As shown in FIG. 8, rectangular box 10 functioned to change volume, installed between two flanges 9a and 9b of the third device cluster 300, the threaded positioning shafts 11a, 11b, 11c, 11d will position the distance between flanges 9a and 9b so that the rectangular box 10 can work, when necessary can change the volume of the largest or smallest according to the invention.

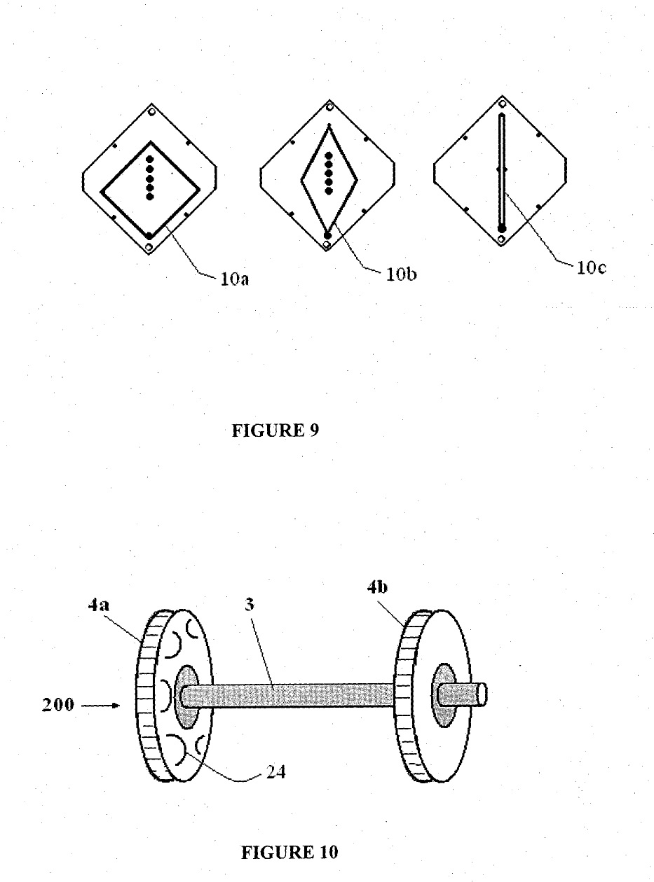

As shown on FIG. 9, an etching simulation, rectangular box 10a is of the largest volume, rectangular box 10b is of medium volume, and rectangular box 10c is of the smallest volume.

As shown in FIG. 10, the second device cluster 200 includes a shaft 3, two gears 4a, 4b and teeth 24.

The benefits of the invention of the engine operated by the buoyancy of water achieved include the continuous operation of the engine to generate electricity without additional input energy so the price of electricity will be very low, having no environmental impact and contributing to solving energy problems.

1. The engine operated by the buoyancy of water, this engine is made up of water tank (16), the first device cluster (100) includes a shaft (1) and two gears (2a), (2b), at the teeth (24) with gasket (27), one-way air supply valve (23), the shaft's center hole (26) connected the hollow chamber of gears (2a, 2b) to the one-way air supply valve (23), the second device cluster (200) includes a shaft (3) and two gears (4a, 4b). There is a difference that the third device clusters (300) includes two flanges (9a , 9b), a rectangular box (10) functioned to change the volume .while coordinating activities with the structure of shaped rails (17) and (18), multiple third device clusters (300) are connected together by latches (15) forming a closed circle, the flanges (9a, 9b) of the closed circle are inserted fit the teeth (24) of the gears (2a, 2b) of the first device cluster (100) and mounted to fit the teeth (24) of the gears (4a, 4b) of the second device cluster (200).
